(19) United States
(12) Patent Application Publication
(10) Pub. No.: US 2012/0226477 A1
(43) Pub. Date: Sep. 6, 2012

(54) Reducing Overhead and Increasing Precision with Code Instrumentation

(75) Inventors: Gheorghe C. Cascaval, Los Altos Hills, CA (US); Jose G. Castanos, Yorktown Heights, NY (US); Yaoqing Gao, North York (CA); Mauricio J. Serrano, Bronx, NY (US)

(73) Assignee: INTERNATIONAL BUSINESS MACHINES CORPORATION, Armonk, NY (US)

(21) Appl. No.: 13/040,749

(22) Filed: Mar. 4, 2011

(51) Int. Cl. G06F 11/34

(52) U.S. Cl. 702/186

(57) ABSTRACT

Mechanisms are provided for performing performance monitoring of code executing in the data processing system. A performance measurement is obtained for the execution of a region of code of interest. A determination is made as to whether an overhead associated with a current performance measurement mechanism is greater than a predetermined threshold amount of the performance measurement for the execution of the region of code of interest. A dynamic switch is performed from the current performance measurement mechanism to a second performance measurement mechanism, having a lower overhead, for obtaining performance measurements for the execution of the region of code of interest in response to the overhead associated with the current performance measurement mechanism being greater than the predetermined threshold amount of the performance measurement for the execution of the region of code of interest.

This invention was made with Government support under Contract No.: HR0011-07-9-0002 awarded by (DARPA) Defense Advanced Research Projects Agency. The Government has certain rights in this invention.

### BACKGROUND

The present application relates generally to an improved data processing apparatus and method and more specifically to mechanisms for reducing overhead and increasing precision with code instrumentation, especially with regions of code having different levels of instrumentation granularities.

Performance measurements of executing code may be used to obtain application behavior understanding, performance analysis, perform regression analysis, and guide optimization decisions for compilers. Typically such performance measurements are obtained from hardware performance counters, i.e. special purpose registers built into the hardware of a system that are used to store an incremented value, and software trace tools. That is, portions of code may be instrumented by inserting hook code into the portions of code. The hook code may cause a corresponding performance counter to increment thereby counting the number of occurrences of a particular event.

Thus, one technique for obtaining performance measurement information is to use these hardware performance counters. I lowever, these hardware performance counters are limited in number and are further limited in a total number of events that can be monitored by the hardware performance counters, i.e. the hardware performance counters are susceptible to counter overflow if too many events are encountered during the execution of the code.

In other mechanisms, performance measurement virtualization software may be used to maintain higher-precision counters through operating system support. One example of performance measurement virtualization software is the Performance Monitoring Application Programming Interface (PMAPI) used with the AIX operating system, both available from International Business Machines Corporation of Armonk, N.Y. While such performance measurement virtualization software provides higher-precision counters, the software is limited in that the instrumentation overhead for implementing these performance measurement virtualization software is relatively high, thereby degrading the performance of the code. Such instrumentation overhead may alter the measurements obtained through the use of the performance measurement virtualization software.

### SUMMARY

In one illustrative embodiment, a method, in a data processing system, is provided for performing performance monitoring of code executing in the data processing system. The method comprises obtaining, by a current performance measurement mechanism of the data processing system, a performance measurement for the execution of a region of code of interest. The method further comprises determining, by the data processing system, whether an overhead associated with the current performance measurement mechanism is greater than a predetermined threshold amount of the performance measurement for the execution of the region of code of interest. Moreover, the method comprises dynamically switching, by the data processing system, from the current performance measurement mechanism to a second performance measurement mechanism, having a lower overhead, for obtaining performance measurements for the execution of the region of code of interest in response to the overhead associated with the current performance measurement mechanism being greater than the predetermined threshold amount of the performance measurement for the execution of the region of code of interest.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example of a distributed data processing system in which aspects of the illustrative embodiments may be implemented;

FIG. 2 is an example block diagram of a data processing system is shown in which aspects of the illustrative embodiments may be implemented;

FIG. 3 is an example block diagram that depicts components used to perform performance tracing of processes in a data processing system in accordance with one illustrative embodiment; and

FIG. 4 is a flowchart outlining an example operation for dynamically adapting performance measurement techniques in accordance with one illustrative embodiment.

### DETAILED DESCRIPTION

The illustrative embodiments provide a mechanism for reducing overhead and increasing precision for instrumentations in regions of code having different granularities. That is, the illustrative embodiments provide a flexible framework in which performance measurements techniques are adapted dynamically as code is being executed so as to obtain the best performance of the executing code while having a lowest overhead. Essentially, the mechanisms of the illustrative embodiments dynamically switch between hardware performance counter based performance measurements and performance virtualization software based on determinations as to which technique for performance measurement is most appropriate under the current conditions of the particular region of code being executed.

Many times it is not possible to determine before code is executed what the instrumentation granularity level is for the code. Instrumentation granularity level is the expected number of trace events that are generated, by inserted instructions, hooks, or the like, for generating such trace events, between entry into a region of code and exiting the region of code. A low instrumentation granularity or granularity level means a relative lower or less number of such events when compared to a high instrumentation granularity or granularity level.

As an example of why it is sometimes not possible to determine the instrumentation granularity level, consider a loop in the code in which the loop upper bounds may vary during program execution, or the upper bounds may not be able to be determined by static program analysis. As a result, it may be difficult to statically determine or estimate the number of instructions executed in the loop.

The method used to perform performance measurements may vary depending upon the instrumentation granularity. For example, if the instrumentation granularity is relatively small, it is preferable to use direct counter readings because the measurements are more accurate due to the instrumentation overhead being relatively smaller. However, because the hardware performance counters have a limited budget, counter overflow may happen and thus, incorrect performance measurement information may be obtained or additional instrumentation for tracking whether a counter overflows may be necessary.

On the other hand, if the instrumentation granularity is high, in order to reduce the possibility of hardware performance counter overflows, performance virtualization software may be utilized. However, since the instrumentation overhead is high for such performance virtualization software, the instrumentation granularity must be relatively high to warrant this overhead, otherwise the overhead may negatively impact the performance measurement information obtained from such performance virtualization software. For example, assume that the desired performance measurement is the number of instructions executed. If the performance measurement information obtained from the performance virtualization software is 10,000 instructions, and it is determined that the instrumentation overhead associated with the performance virtualization software is 1,000 instructions, then there could be a performance measurement error of 10%, i.e. the 1,000 instructions of overhead may introduce a 10% error in the performance measurement information. This may not be satisfactory in many implementations. Thus, a higher instrumentation granularity, e.g., 100,000 instructions, may be necessary to offset the measurement error introduced by the overhead of the performance virtualization software, for example.

The illustrative embodiments provide mechanisms for dynamically determining which approach is more appropriate for the particular performance measurements being performed and the particular regions of code and their associated instrumentation granularities. The instrumentation granularity may be different for different regions of code, e.g., going from lowest instrumentation granularity to highest instrumentation granularity: whole program instrumentation, method/function instrumentation, loop level instrumentation, and individual instruction instrumentation. For higher instrumentation granularities, a performance monitoring software approach may be selected. For a lower instrumentation granularity, a direct hardware performance counter approach may be utilized.

With the mechanisms of the illustrative embodiments, the difference in hardware performance counter readings between the entry/exit of a region of code is tracked. A determination is made as to whether the instrumentation overhead for this region will represent greater than a predetermined percentage of the overall performance measurements. If the overhead is greater than the predetermined percentage of the overall performance measurements, performance virtualization software mechanisms are not used to report performance measurements for the region. Instead, the instrumentation is dynamically switched to a lower overhead mechanism in which performance measurements are taken directly from hardware performance counters. This dynamic switching between performance measurement mechanisms is repeated continuously or periodically during the execution of the code.

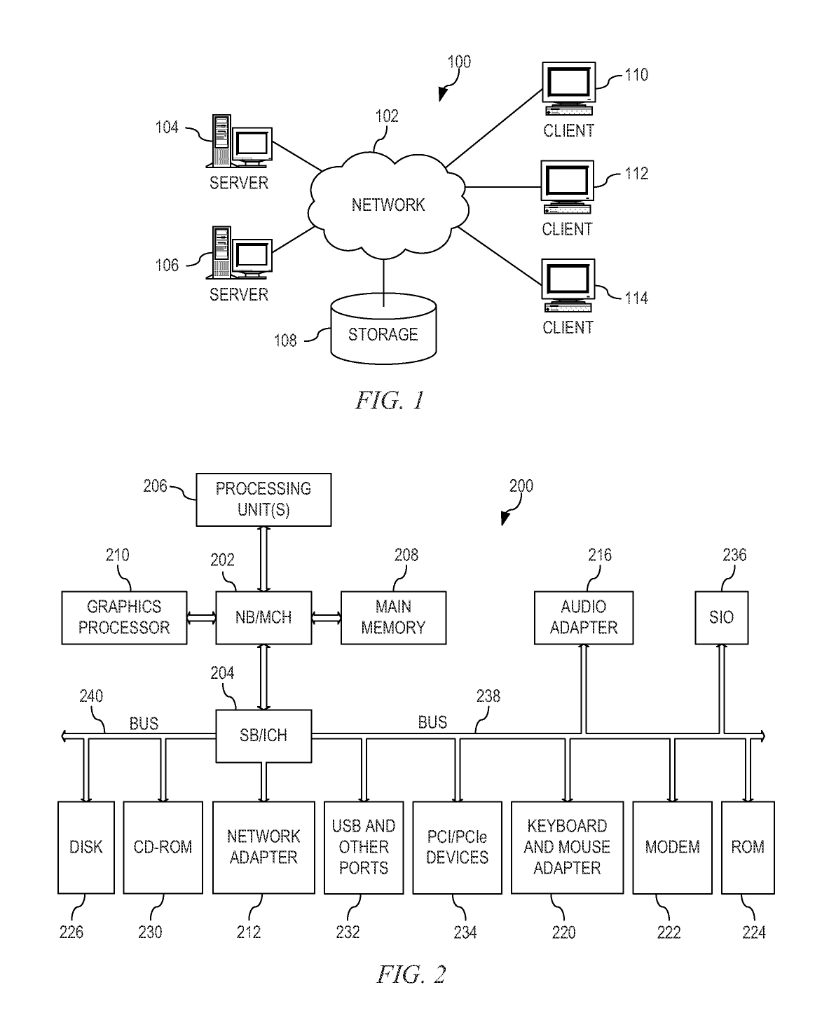

The illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an example data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™ C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

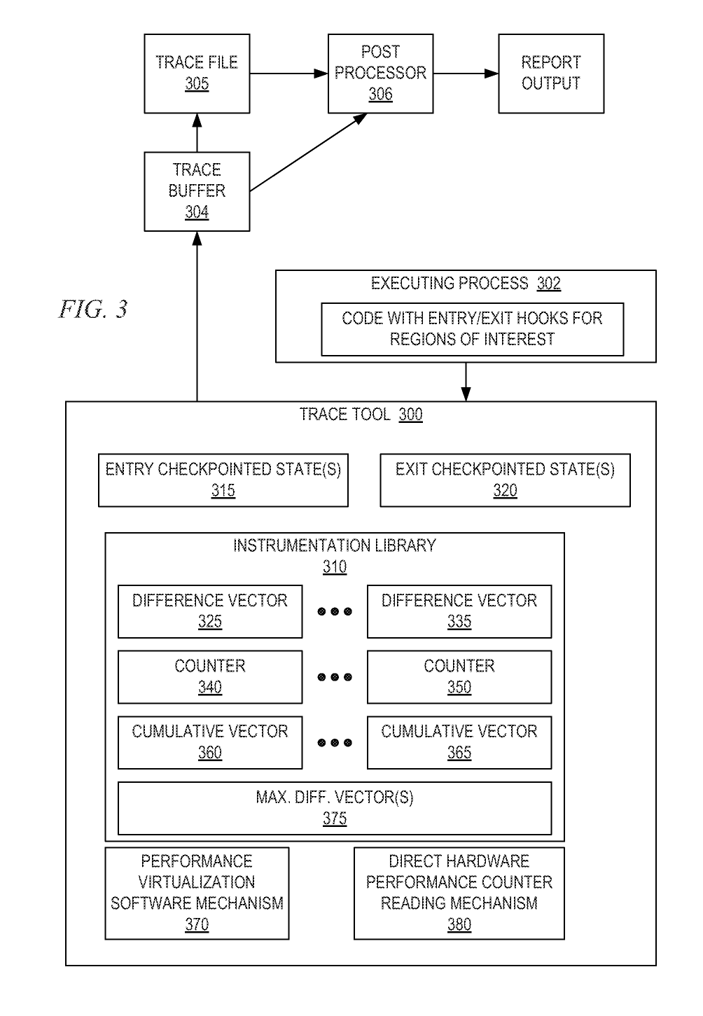

With reference now to FIG. 3, an example block diagram is shown that depicts components used to perform performance tracing of processes in a data processing system in accordance with one illustrative embodiment. Trace tool 300 profiles process 302, which may be a process in an application being traced. Trace tool 300 records data upon the execution of a hook, which is a specialized piece of code at a specific location in a routine or program in which other routines may be connected. Trace hooks are typically inserted for the purpose of debugging, performance analysis, or enhancing functionality. These trace hooks send trace data to trace tool 300, which stores the trace data in buffer 304.

The trace data in buffer 304 may be subsequently stored in trace file 305 or a consolidated buffer when buffer 304 is filled for post-processing. Alternatively, the trace data may be processed in real-time. Post-processor 306 processes the trace data located in either buffer 304 or trace file 305.

In a non-Java environment, trace hooks may aid in the identification of modules that are used in an application under trace. With Java operating systems, trace hooks may aid in identifying loaded classes and methods. In addition, since a class loader may load and unload classes and modules in a Java environment, trace data may also identify these changes. This is especially relevant with “network client” data processing systems, such as those that may operate under Java OS, since the loading and unloading of classes and jitted methods may occur frequently due to the constrained memory and role as a network client. Note that class or module load and unload information are also relevant in embedded application environments, which tend to be memory constrained.

With the mechanisms of the illustrative embodiments, regions of code that are of interest are instrumented with profiling, or “trace,” hooks using either instrumentation calls to one or more runtime routines or direct in-lining of instrumentation code. The instrumentation routines or in-lined instrumentation code is referred to herein as the instrumentation library 310. The instrumentation library 310 is a variety of tools that modify an existing binary code, without altering the original behavior of the binary code, in order to record additional behavior information while a program is executing. The instrumentation library operates to gather performance measurement information from hardware performance counters or other performance measurement devices at a particular point in time at which the instrumentation library is invoked.

With the illustrative embodiments, the instrumentation library is called or executed before the region of code is entered, by executing a profiling hook inserted into the code just prior to the region of code of interest, so as to generate a snapshot of the performance measurements of interest. This is referred to as obtaining an entry checkpointed state 315 for the region of code. The instrumentation library is called or executed again after the region of code is executed, thereby generating an exit checkpointed state 320 for the region of code. The entry/exit checkpointed states may be communicated to the trace tool 300. The difference between the entry/exit checkpointed states provides a measurement of the execution characteristics of the region of code.

The difference may be in many different performance counters. That is, the checkpointed states may comprise a plurality of performance counter values and thus, the difference between states may be represented as multiple differences, one for each performance counter or for a subset of the performance counters. These differences may be stored in a difference vector 325 maintained by the instrumentation library 310, where the difference vector 325 has an entry for each performance measurement of interest, e.g., each hardware performance counter of interest. There may be a separate difference vectors 325-335 maintained in the instrumentation library 310 for each region of interest of the code, e.g., each routine, method, loop, instruction, etc., of interest.

The instrumentation library 310 may maintain a count, such as in a counter 340-350, for each region of interest, of the number of times the instrumentation library 310 is called or executed. The instrumentation library 310 may further maintain, for each region of interest, a cumulative vector 360-365 that stores a cumulative amount of the differences measured by the instrumentation library 310. The difference values, or performance measurements of the particular regions of code, gathered by the instrumentation library 310 may be reported as the cumulative vector 360-365 normalized by the corresponding counter 340-350 value. In this way, averages of the difference values or performance measurements for the regions of code are generated and reported. That is, the cumulative vector 360-365 may be used to report normalized measurements, e.g., the number of events per instrumentation measurements is equal to a cumulative amount divided by the number of instrumentation measurements.

Initially, a performance virtualization software mechanism 370, such as the Performance Monitoring Application Programming Interface (PMAPI) used with the AIX operating system, both available from International Business Machines Corporation of Armonk, N.Y., for example, may be used to gather performance measurement information, such as from hardware performance counters and the like. The performance virtualization software mechanism 370 is utilized initially because it reduces the possibility of an overflow happening in the hardware performance counters.

The difference vector 325 is computed by the instrumentation library 310 and analysis is performed for each measurement of interest in the difference vector 325 to determine a maximum difference vector 375. Each entry in the maximum difference vector 375 stores the maximum difference encountered by the instrumentation library 310 for the particular measurement over a predetermined period of time over which the measurements are taken, whether that be less than the total execution time of the code or the entire execution time of the code. In one illustrative embodiment, the maximum difference vector 375, or individual entries in the maximum difference vector 375 may be reset periodically so that the instrumentation library of the illustrative embodiments may react dynamically to changes in instrumentation granularity.

The maximum difference vector 375 for a region of interest may be used as a basis for determining whether to continue to use the performance virtualization software mechanism 370 or switch to a direct hardware performance counter reading mechanism 380. For example, if the maximum difference vector 375 for a region of code has a measurement corresponding to a maximum number of instructions executed in the region of code, this number of instructions may be compared by the instrumentation library 310 with the known overhead associated with the performance virtualization software mechanism 370. If the known overhead of the performance virtualization software mechanism 370 is more than a predetermined threshold amount, e.g., 10 percent or more, of the maximum number of instructions executed by the region of code, then the region of code may have an annotation inserted into the hook instrumentation to indicate that the direct hardware performance counter reading mechanism 380 should be used instead of the performance virtualization software mechanism 370. Such annotations may be made, for example, by setting a value in the hook instrumentation, for example. Otherwise, the performance virtualization software mechanism 370 may be utilized. Thus, unless such an annotation is provided in the hook instrumentation, the performance virtualization software mechanism 370 is utilized as a default. Each region of interest will therefore fall in one of two categories, either a region of code whose performance is monitored by a performance virtualization software mechanism 370 or a region of code whose performance is monitored by direct hardware performance counter reading.

If the direct hardware performance counter reading 380 is used in subsequent calls to the instrumentation library, then counter readings are used to determine if a counter overflow has happened or not. The difference vector 325 is computed for all measurements of interest for the region of code and overflow is detected by comparing the difference vector 325 to the corresponding maximum difference vector 375. If the difference vector for the particular measurement exceeds several times the corresponding maximum difference vector 375 measurement value, then overflow may be suspected and the measurement instance may be discarded with updating of the cumulative vector 360-365 and counter of the number of times the instrumentation library 310 is called not being performed.

The difference vector 325 may be used not only to update the maximum difference vector 375 for purposes of selecting which performance monitoring mechanism 370 or 380 to utilize, but may also be used to determine whether particular measurements are likely to introduce an error in measurements or not. For example, if one entry in the difference vector 325 is used for tracking the number of instructions and the known overhead of the performance virtualization software mechanism 370 is a predetermined threshold amount, e.g., 10 percent or more, of the difference value representing the number of instructions executed for the region of code, then it may be determined that the performance measurements associated with the execution of the region of code may have errors introduced by having to execute the performance virtualization software mechanism 370. Such an error estimation may be determined for each measurement of interest represented in the difference vector 375 and a maximum error amount may be computed. If the maximum error estimation exceeds a maximum allowed error, the difference vector 375 may not be used for the cumulative statistics in the cumulative vector 360-365. The region of code may not be updated and the counter of the number of calls of the instrumentation library 310 may not be incremented.

Thus, the illustrative embodiments provide a mechanism for dynamically adapting the mechanisms used to determine performance monitoring so that overall the highest precision with the lowest overhead is achieved. With these mechanisms higher precision is achieved by using performance virtualization software as a default. Direct hardware performance counter reading is used when the overhead associated with the performance virtualization software represents a significant enough portion of the performance measurements and thus, may introduce errors into the measurements themselves.

It should be appreciated that while the above illustrative embodiments are described in terms of the difference vector and maximum difference vector being used as a basis for determining switching between performance measurement mechanisms. However, the present invention is not limited to such. Rather, any mechanism for determining whether the overhead of one type of performance measurement mechanism represents a significant portion of the performance measurement, as determined by a threshold amount of the performance measurement, for example, may be used without departing from the spirit and scope of the illustrative embodiments. For example, rather than using the difference vector and maximum difference vector, the cumulative vector may be used along with the counter's count value to obtain an average difference value and this average difference value may be used as a basis for determining whether to make a dynamic switch of the performance measurement mechanisms based on the overhead of the current performance measurement mechanism being used.

In addition, while the above illustrative embodiments are described in terms of switching between a performance virtualization software mechanism and direct hardware performance counter reading mechanism, the illustrative embodiments are not limited to such. Rather, the illustrative embodiments may dynamically adapt to using any type of performance measurement mechanism from any current type of performance measurement mechanism being used based on the relative overhead of the performance measurement mechanisms and their relation to the performance measurement. That is, the switching can be performed between two different types of performance virtualization software mechanisms, different types of direct hardware performance counter reading mechanisms, or any combination of these types of performance measurement mechanisms, for example.

Moreover, there may be more than one alternative mechanism for performing the performance measurements rather than only switching between two performance measurement mechanisms. In such a situation, a performance measurement mechanism may be selected from more than one alternative mechanism based on a mechanism having a low enough overhead such that it does not exceed the predetermined threshold amount of the performance measurement but has a highest precision of the alternatives. Thus, the instrumentation library may not always select the alternative with the lowest overhead but may select a higher overhead alternative mechanism that provides a higher precision than the alternative having the lowest overhead. Such alternatives may have metadata associated with them that defines their overhead and relative level of precision so that the instrumentation library may make such decisions. This metadata may be stored in a data structure within the instrumentation library, for example.

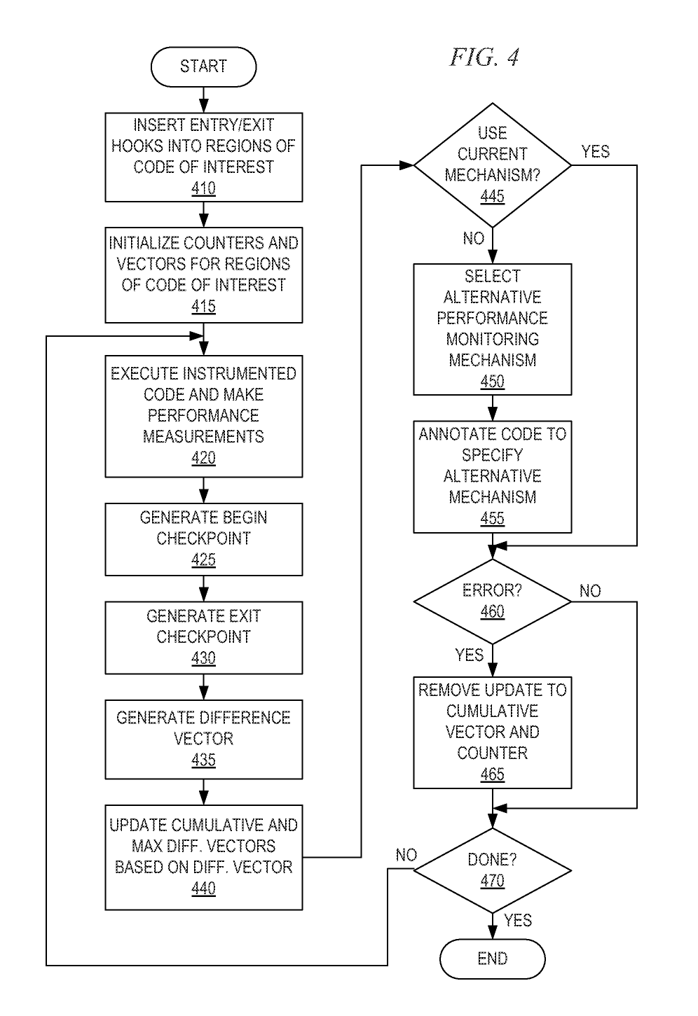

FIG. 4 is a flowchart outlining an example operation for dynamically adapting performance measurement techniques in accordance with one illustrative embodiment. As shown in FIG. 4, the operation starts by instrumenting code by inserting hooks at portions or regions of code of interest within the code such that a hook is placed at the beginning and end of each region of code of interest (step 410). Hardware performance counters, difference vectors, maximum difference vectors, cumulative vectors, and counters for each region of code of interest are generated and initialized (step 415). The instrumented code is executed (step 420) and performance measurements are made using the hardware performance counters. In response to the execution of a begin hook for a next region of code of interest, a begin checkpoint of the performance measurements of interest is generated (step 425). Thereafter, in response to the execution of the end hook for the region of code of interest, an end checkpoint of the performance measurements of interest is generated (step 430).

A difference vector associated with the region of code of interest is updated with the differences between the begin and end checkpoints for each measure of interest (step 435). The difference vector is further used to update a cumulative vector and maximum difference vector for the region of code of interest (step 440).

Based on one or more of these vectors, a determination is made as to whether performance measurements should continue to be obtained using a current performance measurement mechanism of if performance measurements should be obtained using a second performance measurement mechanism having a relatively lower overhead (step 445). For example, this determination may be made by determining if a known overhead of a current performance measurement mechanism, such as a performance virtualization software mechanism, represents a predetermined threshold amount, e.g., 10%, of a maximum difference for one or more of the performance measurements in the maximum difference vector or one or more of the difference values in the difference vector.

If the determination is that a switch should be made, then an alternative performance measurement mechanism is selected (step 450) and the region of code is annotated to identify the particular performance measurement mechanism to be used for that region of code (step 455). For example, if only one other alternative is provided, e.g., direct hardware performance counter reading, then the region of code is annotated in the performance or “trace” hook code to identify that direct hardware performance counter reading is to be performed with regard to that region of code. If more than one alternative is possible, then an appropriate annotation is provided in the hook code indicating which alternative to use.

In addition, a determination is made based on one or more of these vectors as to whether a relatively high likelihood of an error may be introduced by the performance measurements (step 460). For example, if the overhead of the current performance measurement mechanism is greater than a predetermined threshold amount of a corresponding current performance measurement, as represented by a difference value in the difference vector, then it may be determined that the overhead may introduce an error in the performance measurement. As a result, the performance measurement may be discarded and not used to update cumulative vectors or the counter count for the region of code (step 465).

A determination is made as to whether execution of the code is terminated (step 470). If not, the operation returns to step 420 and the execution of the code continues. If execution of the code is terminated, the operation ends.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for performing performance monitoring of code executing in the data processing system, comprising:
obtaining, by a current performance measurement mechanism of the data processing system, a performance measurement for the execution of a region of code of interest;
determining, by the data processing system, whether to switch from the current performance measurement mechanism to a second performance measurement mechanism based on the performance measurement for the executing of the region of code of interest; and
dynamically switching, by the data processing system during execution of the code, from the current performance measurement mechanism to a second performance measurement mechanism, having a lower overhead, for obtaining performance measurements for the execution of the region of code of interest in response to determining that a switch from the current performance measurement mechanism to the second performance measurement mechanism is to be performed.

2. The method of claim 1, wherein determining whether to switch from the current performance measurement mechanisms to a second performance measurement mechanism comprises determining whether an overhead associated with the current performance measurement mechanism is greater than a predetermined threshold amount of the performance measurement for the execution of the region of code of interest, and wherein the dynamic switching is performed in response to the overhead associated with the current performance measurement mechanism being greater than the predetermined threshold amount of the performance measurement for the execution of the region of code of interest.

3. The method of claim 1, wherein the current performance measurement mechanisms is one of a performance virtualization software mechanism and a direct hardware performance counter reading mechanism, and wherein the second performance measurement mechanism is an other of the performance virtualization software mechanism and the direct hardware performance counter reading mechanism.

4. The method of claim 1, wherein the code comprises a plurality of regions of code and wherein different performance measurement mechanisms are utilized for at least two regions of code in the plurality of regions of code.

5. The method of claim 1, wherein determining whether to switch from the current performance measurement mechanism to a second performance measurement mechanism comprises:
determining an instrumentation granularity level of the region of code of interest; and
determining whether to switch from the current performance measurement mechanism to a second performance measurement mechanism based on the instrumentation granularity level of the region of code.

6. The method of claim 1, wherein the method is performed by an instrumentation library, and wherein obtaining the performance measurement for the execution of a region of code of interest comprises:
invoking the instrumentation library prior to executing the region of code of interest to generate a first checkpoint state;
invoking the instrumentation library after execution of the region of code of interest to generate a second checkpoint state; and
determining the performance measurement based on a difference between the first checkpoint state and second checkpoint state.

7. The method of claim 6, wherein:
the first checkpoint state and second checkpoint state comprise one or more performance counter values associated with the execution of the region of code of interest,
the difference between the first checkpoint state and second checkpoint state is stored in a difference vector storage device, and
the difference vector storage device comprises an entry for each performance measurement of interest associated with the region of code of interest.

8. The method of claim 6, further comprising:
storing, in a cumulative vector storage device, a cumulative amount of the differences between the first checkpoint state and second checkpoint state for the performance measurement and the region of code of interest.

9. The method of claim 6, further comprising:
storing, in a maximum difference vector storage device, a maximum difference for each performance parameter encountered by the instrumentation library for the region of code of interest over a predetermined period of time.

10. The method of claim 9, wherein determining whether to switch from the current performance measurement mechanism to a second performance measurement mechanism comprises:
comparing a maximum difference corresponding to the performance measurement with a known overhead associated with the current performance measurement mechanism; and
determining that a switch from the current performance measurement mechanism to the second performance measurement mechanism is to be performed in response to the overhead associated with the current performance measurement mechanism being more than a predetermined threshold amount of the maximum difference corresponding to the performance measurement.

11. A computer program product comprising a computer readable storage medium having a computer readable program stored therein, wherein the computer readable program, when executed on a computing device, causes the computing device to:
obtain, by a current performance measurement mechanism of the computing device, a performance measurement for the execution of a region of code of interest;
determine, by the computing device, whether to switch from the current performance measurement mechanism to a second performance measurement mechanism based on the performance measurement for the executing of the region of code of interest; and
dynamically switch, by the computing device during execution of the code, from the current performance measurement mechanism to a second performance measurement mechanism, having a lower overhead, for obtaining performance measurements for the execution of the region of code of interest in response to determining that a switch from the current performance measurement mechanism to the second performance measurement mechanism is to be performed.

12. The computer program product of claim 11, wherein the computer readable program causes the computing device to determine whether to switch from the current performance measurement mechanisms to a second performance measurement mechanism by determining whether an overhead associated with the current performance measurement mechanism is greater than a predetermined threshold amount of the performance measurement for the execution of the region of code of interest, and wherein the dynamic switching is performed in response to the overhead associated with the current performance measurement mechanism being greater than the predetermined threshold amount of the performance measurement for the execution of the region of code of interest.

13. The computer program product of claim 11, wherein the current performance measurement mechanisms is one of a performance virtualization software mechanism and a direct hardware performance counter reading mechanism, and wherein the second performance measurement mechanism is an other of the performance virtualization software mechanism and the direct hardware performance counter reading mechanism.

14. The computer program product of claim 11, wherein the code comprises a plurality of regions of code and wherein different performance measurement mechanisms are utilized for at least two regions of code in the plurality of regions of code.

15. The computer program product of claim 11, wherein the computer readable program causes the computing device to determine whether to switch from the current performance measurement mechanism to a second performance measurement mechanism by:
determining an instrumentation granularity level of the region of code of interest; and
determining whether to switch from the current performance measurement mechanism to a second performance measurement mechanism based on the instrumentation granularity level of the region of code.

16. The computer program product of claim 11, wherein the obtaining, determining, and dynamically switching are performed by an instrumentation library invoked by the execution of the computer readable program, and wherein the computer readable program causes the computing device to obtain the performance measurement for the execution of a region of code of interest by:
invoking the instrumentation library prior to executing the region of code of interest to generate a first checkpoint state;
invoking the instrumentation library after execution of the region of code of interest to generate a second checkpoint state; and
determining the performance measurement based on a difference between the first checkpoint state and second checkpoint state.

17. The computer program product of claim 16, wherein:
the first checkpoint state and second checkpoint state comprise one or more performance counter values associated with the execution of the region of code of interest,
the difference between the first checkpoint state and second checkpoint state is stored in a difference vector storage device, and
the difference vector storage device comprises an entry for each performance measurement of interest associated with the region of code of interest.

18. The computer program product of claim 16, wherein the computer readable program further causes the computing device to:
store, in a cumulative vector storage device, a cumulative amount of the differences between the first checkpoint state and second checkpoint state for the performance measurement and the region of code of interest.

19. The computer program product of claim 16, wherein the computer readable program further causes the computing device to:
store, in a maximum difference vector storage device, a maximum difference for each performance parameter encountered by the instrumentation library for the region of code of interest over a predetermined period of time.

20. The computer program product of claim 19, wherein the computer readable program further causes the computing device to determine whether to switch from the current performance measurement mechanism to a second performance measurement mechanism by:
comparing a maximum difference corresponding to the performance measurement with a known overhead associated with the current performance measurement mechanism; and
determining that a switch from the current performance measurement mechanism to the second performance measurement mechanism is to be performed in response to the overhead associated with the current performance measurement mechanism being more than a predetermined threshold amount of the maximum difference corresponding to the performance measurement.

21. An apparatus, comprising:
a processor; and
a memory coupled to the processor, wherein the memory comprises instructions which, when executed by the processor, cause the processor to:
obtain, by a current performance measurement mechanism, a performance measurement for the execution of a region of code of interest;
determine whether to switch from the current performance measurement mechanism to a second performance measurement mechanism based on the performance measurement for the executing of the region of code of interest; and
dynamically switch, during execution of the code, from the current performance measurement mechanism to a second performance measurement mechanism, having a lower overhead, for obtaining performance measurements for the execution of the region of code of interest in response to determining that a switch from the current performance measurement mechanism to the second performance measurement mechanism is to be performed.

22. The apparatus of claim 21, wherein the instructions cause the processor to determine whether to switch from the current performance measurement mechanisms to a second performance measurement mechanism by determining whether an overhead associated with the current performance measurement mechanism is greater than a predetermined threshold amount of the performance measurement for the execution of the region of code of interest, and wherein the dynamic switching is performed in response to the overhead associated with the current performance measurement mechanism being greater than the predetermined threshold amount of the performance measurement for the execution of the region of code of interest.

23. The apparatus of claim 21, wherein the current performance measurement mechanisms is one of a performance virtualization software mechanism and a direct hardware performance counter reading mechanism, and wherein the second performance measurement mechanism is an other of the performance virtualization software mechanism and the direct hardware performance counter reading mechanism.

24. The apparatus of claim 21, wherein the code comprises a plurality of regions of code and wherein different performance measurement mechanisms are utilized for at least two regions of code in the plurality of regions of code.

25. The apparatus of claim 21, wherein the instructions cause the processor to determine whether to switch from the current performance measurement mechanism to a second performance measurement mechanism by:
determining an instrumentation granularity level of the region of code of interest; and
determining whether to switch from the current performance measurement mechanism to a second performance measurement mechanism based on the instrumentation granularity level of the region of code.
